(19) United States
(12) Patent Application Publication
(10) Pub. No.: US 2008/0086234 A1
(43) Pub. Date: Apr. 10, 2008

(54) FUEL DISPENSER USING INTELLIGENT INTERMEDIARIES

(75) Inventor: Dave Dodson, Virginia Beach, VA (US)

Correspondence Address: BAKER & DANIELS LLP;111 E. WAYNE STREET, SUITE 800, FORT WAYNE, IN, 46802, US

(73) Assignee: TOKHEIM HOLDING, B.V., Ad Bladel (NL)

(21) Appl. No.: 11/868,579

(22) Filed: Oct. 8, 2007

Related U.S. Application Data
(63) Continuation of application No. 10/304,169, filed on Nov. 26, 2002, now abandoned.
(60) Provisional application No. 60/333,394, filed on Nov. 27, 2001.

(51) Int. Cl. G06F 17/00

(52) U.S. Cl. 700/231

(57) ABSTRACT

A fueling-station information-processing network is disclosed for a fueling station that comprises one or more fuel-dispenser stations each of which comprises one or more fuel dispensers for controlling transfer of fuel purchased by a customer from a fuel vendor's fuel-storage tank to the customer's fuel reservoir. The fueling-station information-processing network comprises one or more fuel-dispenser information-processing device(s) that are mounted to one or more of the fuel-dispenser stations and that perform the functions of controlling operation of the fuel-dispenser station and/or displaying information upon display screens for viewing by the customer. One or more of the fuel-dispenser information-processing device(s) of the fueling-station information-processing network are communicatively linked to a proxy server, which is communicatively linked, in turn, to a host server. The invention includes novel methods of operation of the fueling-station information-processing network that capitalize on the configuration of the fueling-station information-processing network.

The present application hereby claims the benefit under Title 35, United States Code §119(e) of U.S. provisional application No. 60/333,394 filed Nov. 27, 2001.

### BACKGROUND OF THE INVENTION

1. Field of the Invention

The present invention relates to an information-processing network for a fueling station and methods of operating such an information-processing network.

2. Description of the Related Art

Fueling stations comprise one or more fuel-dispenser stations each of which comprises one or more fuel dispensers for controlling dispensation of fuel from a fuel vendor's storage tank to a customer's fuel reservoir. It is known to mount fuel-dispenser information-processing devices in the fuel-dispenser stations of fueling stations. Such fuel-dispenser information-processing devices are used to perform one or more functions that may include but are not limited to controlling and/or monitoring operation of the fuel-dispenser station, enabling a customer to pay for purchases at the fuel-dispenser station with a credit card, and displaying information upon display screens of the fuel dispenser information-processing devices. It is also known to communicatively link the fuel-dispenser information-processing devices of a fueling station to one or more other information-processing devices such as one or more servers and to, thus, form a fueling-station information-processing network. Linking fuel-dispenser information-processing devices into a fueling-station information-processing network enables passing of information between each fuel-dispenser information-processing device and other information processing-devices in the fueling-station information-processing network.

Opportunities exist, however, to improve upon known fueling-station information-processing networks and methods of operating them. Known fueling-station information-processing networks are configured and operated in manners such that they are vulnerable to tampering by malefactors with access to information-processing devices communicatively linked directly or indirectly to the fueling-station information-processing network.

Additionally, there are known limitations associated with methods of displaying information upon display screens of fuel-dispenser information-processing devices of known fueling-station information-processing networks. In many cases, the information that is to be displayed upon display screens of fuel-dispenser information-processing devices is contained within electronic data-files stored within computer memory of other information-processing device(s) communicatively linked to the fuel dispenser information-processing devices. As an example, the information that is to be displayed upon the display screens is often contained in web-pages files (generally HTML files) stored on servers to which the fueling-station information processing network is communicatively linked. Additionally, the display capabilities of the display screens are often less than adequate to display the electronic data-files in the form in which they exist in memory of the communicatively linked information-processing device. For instance, a display screen of a fuel-dispenser information-processing device may be a 4-line display screen. Such a 4-line display screen has insufficient display capabilities to display an entire web-page. Thus, in such a situation, if information from the web-page is to be displayed upon the 4-line display screen, an information-processing device must create a reduced-content electronic-data-file by selecting information from the electronic-data-file that defines the web-page and formatting that information for display upon the 4-line display. To provide at each fuel-dispenser information-processing device processing capabilities and computer memory to undertake the task of creating reduced-content electronic-data-files formatted for display upon whatever type of display screen the fuel-dispenser information-processing device comprises is rather expensive.

Known methods of operating fueling-station information-processing networks also allow customers to operate customer interfaces of the fueling-station information-processing networks to command the fueling-station information-processing network to display web-pages of their choice upon display screens of fuel-dispenser information-processing devices. Enabling a customer to browse through various web-pages at the fuel-dispenser stations has advantages in that it can attract customer business by allowing them to gain valuable information such as news, weather, and driving directions. Enabling a customer to browse various web-pages in such a manner can also boost revenues by exposing the customer to advertising for the fuel vendor's products and services and also by collecting fees from others who advertise products and services via display upon display screens at the fuel-dispenser stations. One disadvantage to allowing a customer to browse various web-pages at the fuel-dispenser information-processing devices is that, if the customer is allowed to navigate completely unchecked, the customer may spend excessive quantities of time at the fuel-dispenser station viewing web-pages that do not contribute to increasing revenues of the fuel vendor. By spending excessive amounts of time at the fuel-dispenser station viewing web-pages, a customer reduces the revenue generating potential of the fuel-dispenser station because other potential customers are prevented from utilizing the fuel-dispenser station to purchase fuel or other goods and services.

### SUMMARY OF THE INVENTION

According to the present invention a fueling-station information-processing network comprises one or more fuel-dispenser information-processing devices, each of which is mounted to a fuel-dispenser station. The fueling-station information-processing network of the present invention also comprises a proxy server to which one or more of the fuel-dispenser information-processing devices are communicatively linked. The fueling-station information-processing network further comprises one or more host servers each of which is communicatively linked directly or indirectly to the proxy server.

The invention, in one form thereof comprises operating instructions according to which the proxy server operates and which are effective to verify the integrity and completeness of electronic data-files utilized by the fueling-station information-processing network. These operating instructions cause the proxy server to perform check sum operations upon electronic data-files received from the host server in order to validate the integrity and completeness of the electronic data-files. Operation of the fueling-station information-processing network in such a manner significantly reduces the probability of undesirable events occurring as a result of a malefactor, with access to an information-processing device communicatively linked to the fueling-station information-processing network, tampering with electronic data-files transmitted to the proxy server thereof.

The invention, in another form thereof allows customers to browse web-pages that are contained in a predetermined-list of preferred web-pages stored in the proxy server, the host server, and/or other servers to which the host server may be communicatively linked. In this embodiment of the invention one or more of the fuel-dispenser information-processing device(s) comprise display screen(s) upon which web-pages or information derived from web-pages may be displayed. In this embodiment of the invention one or more of the fuel-dispenser information-processing device(s) comprise customer interface(s) that customers may use to communicate with the fueling-station information-processing network. According to this embodiment of the invention a customer operates one of the customer interface(s) to communicate, to the fueling-station information-processing network, a request to view a web-page of their choice or information derived from a web-page of their choice. According to this embodiment of the invention a predetermined list of preferred web-pages is stored in computer memory of the fuel-dispenser information-processing device(s), the proxy server, and/or the host server. After the fueling-station information-processing network receives a request from a customer to view a web-page or information derived from a web page of the customer's choice, the fueling-station information-processing network checks to see if the web-page of the customer's choice is included in the predetermined-list of preferred web-pages. If the web-page of the customer's choice is included in the predetermined-list of preferred web-pages, then the fueling-station information-processing network retrieves the web-page file corresponding to the web-page of the customer's choice and displays the web-page or a derivative thereof upon one or more of the display screen(s). By allowing a fuel vendor to limit the web-pages that a customer can browse, such an embodiment of the present invention allows a fuel vendor to limit the customer's browsing of web-pages to browsing of web-pages that the fuel vendor feels will contribute to increased revenues.

In another form thereof, the fuel-dispenser information-processing-devices of the fueling-station information-processing network comprise two or more display screens which are of two or more different types with differing display capabilities. According to this embodiment of the invention, the proxy server receives from the host server a source electronic-data-file that comprises text, graphics, and/or pictures for display upon the display screens. After receiving the source electronic-data-file, the proxy server transmits the source electronic-data-file to any fuel-dispenser information-processing device(s) that have display capabilities sufficient to allow display of the contents of the source electronic-data-file without modification. The proxy server additionally creates from the source electronic-data-file one or more types of reduced-content electronic-data-file(s) by selecting a subset of the text, graphics, and/or pictures of the source electronic-data-file and formatting the selected text, graphics, and/or pictures for display upon a display screen. Each type of reduced-content electronic-data-file created by the proxy server has content and formatting that is tailored for display upon one the types of display screens of the fueling-station information-processing network. After the proxy server creates the one or more types of reduced-content electronic-data-file(s), each type of reduced-content electronic-data-file is transmitted to fuel-dispenser information-processing-device(s) with display screens(s) that have display capabilities for which that type of reduced-content electronic-data-file is configured. This embodiment of the present invention provides a cost effective way to display information from a common source electronic-data-file, such as a web-page file, upon display screens, of a fueling-station information-processing network, which have differing display capabilities.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a perspective view of one embodiment of a fueling-station information-processing network according to the present invention with casings of the fuel-dispenser stations thereof partially cutaway to show the fuel-dispenser information-processing devices mounted therein;

FIG. 2 shows a display screen 13 and a customer interface which comprises operating buttons disposed adjacent the display screen and web-page identifiers displayed upon the display screen in such a matter that each of the web-page identifiers can be understood to correspond to one of the operating buttons;

FIG. 3a shows a display screen with a weather related web page displayed thereupon;

FIG. 3b shows a display screen with somewhat limited display capabilities with information derived from a weather related web page displayed thereupon; and

FIG. 3c shows a display screen with very limited display capabilities with information derived from a weather related web page displayed thereupon.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

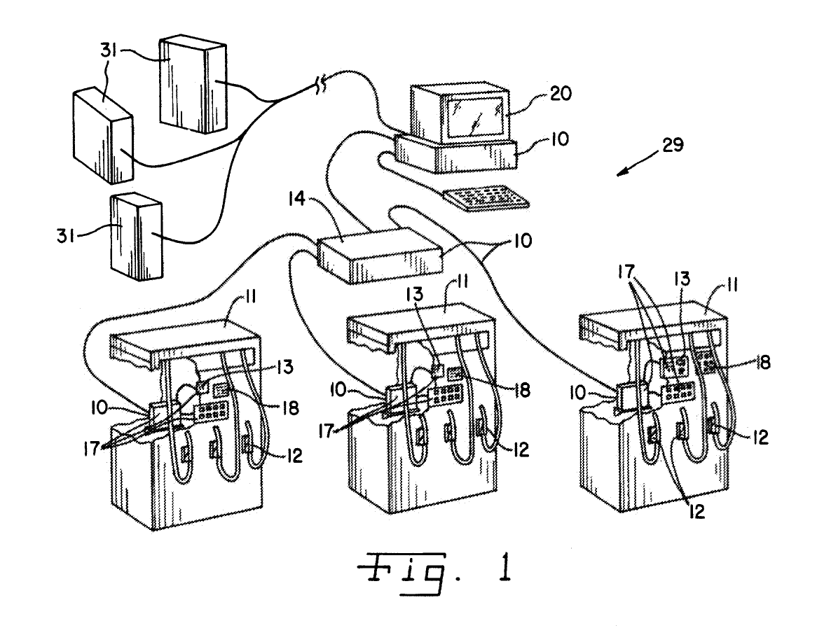

Referring now to the drawings and particularly to FIG. 1, there is shown a fueling-station information-processing network 10 of a fueling station 29. The fueling station 29 of the present invention has any of a large number of well-known configurations including one or more fuel-dispenser stations 11 each of which comprises one or more fuel dispensers 12. Each of the fuel-dispenser stations 11 and the fuel dispensers 12 thereof are operable to transfer fuel, being purchased from a fuel vendor by a customer, from the fuel vendor's storage tank to the customer's fuel reservoir.

The fueling-station information-processing network 10 comprises one or more fuel-dispenser information-processing device(s) 17 mounted to one or more of the fuel-dispenser station(s) 11. Each of the fuel-dispenser information-processing device(s) 17 is operable to perform functions which may include but are not limited to controlling operation of the fuel-dispenser station 11, facilitating payment for goods and services by use of a credit card at the fuel-dispenser station 11, and displaying information for viewing by the customer. According to the present invention the fueling-station information-processing network 10 further comprises a proxy server 14, which is communicatively linked to one or more of the fuel-dispenser information-processing device(s) 17. The proxy server 14 is preferably physically located at the fueling station 29, but may be physically located virtually anywhere. A host server 20 is, in turn, communicatively linked to the proxy server 14. The host server 20 may, additionally, be communicatively linked to one or more other servers 31 as is depicted in FIG. 1. The means employed to communicatively link each of the information-processing devices of the fueling-station information-processing network 10 to one another may comprise any of a number of well known configurations of conductors extending between the information-processing devices and/or electromagnetic waves transmitted and received by transceivers of the information-processing devices. The host server 20 may be physically located at the fueling station 29 or may be located elsewhere. Additionally, the host server 20 may be owned and operated by the fuel vendor or by another party. Such a construction of a fueling-station information processing network 10 is cost effective because the proxy server 14 can perform processing tasks that might otherwise have to be performed by each of the fuel-dispenser information-processing device(s) 17 of the fueling-station information-processing network. Because the proxy server 14 removes processing burden from them, the fuel-dispenser information-processing device(s) 17 can be configured with relatively minimal processing capabilities and computer memory. Using fuel-dispenser information-processing device(s) 17 of limited sophistication is particularly cost effective for fueling-station information-processing networks 10 with many fuel-dispenser information-processing device(s) 17.

Communicatively linking the one or more fuel-dispenser information-processing device(s) 17 to the host server 20 through the proxy server 14 allows for efficient transfer of information from the host server 20 to the fuel-dispenser information-processing device(s) 17 and also in the opposite direction. This configuration of the fueling-station information-processing network 10 allows information that is to be transmitted to the fuel-dispenser information-processing device(s) 17 to be transmitted from the host server 20 in electronic data-files that are compressed such as ZIP files. Such compressed files can be quickly and efficiently transmitted over the communicative link between the host server 20 and the proxy server 14. Once the proxy server 14 receives the compressed electronic-data-files, the proxy server 14 can decompress the electronic-data-files and subsequently transmit the resulting decompressed electronic-data-files or derivatives thereof to the fuel-dispenser information-processing device(s) 17.

In many cases the host server 20 of the fueling-station information-processing network 10 is communicatively linked to other information networks such as the world wide web. In such a situation, if security measures are not implemented, it can be relatively easy for skilled computer users to maliciously alter electronic data-files utilized by the host server 20, the proxy server 14, and/or fuel-dispenser information-processing device(s) 17. As is well known, such malicious tampering, which is commonly known as hacking, can have significant negative consequences for the fuel vendor and/or the customer. The fueling-station information-processing network 10 of the present invention may have operating instructions that effect a method of operation of the fueling-station information processing network 10, which guards against malefactors maliciously tampering with electronic data-files utilized by the fueling-station information-processing network 10. The proxy server 14 may receive, from the host server 20, electronic data-files and the proxy server 14 may transmit to the fuel-dispenser information-processing device(s) 17 electronic data-files. The electronic data-files transmitted between the information-processing devices of the fueling-station information-processing network 10 may be of any of a number of different types. The electronic data-files may comprise fuel-dispenser operating-instructions for controlling the operation of one or more of the information-processing devices of the fueling-station information-processing network 10. The electronic data-files may comprise text, graphics, and/or pictures for display upon one or more display screen(s) 13, which the fueling-station information-processing network 10 may comprise. According to one embodiment of the present invention operating instructions that control a portion of the operation of the proxy server 14 cause the proxy server 14 to perform a check sum operation upon electronic data-files received from the host server 20 to validate their integrity and completeness. If the check sum operation verifies that the electronic data-file received from the host server 20 is correct and complete the proxy server 14 utilizes the electronic data-file in whatever manner it was intended to be utilized. If execution of the check sum operation discovers that the electronic data-file is incorrect or incomplete the proxy server 14 does not utilize the electronic data-file and, thus, averts the likely adverse consequences of utilizing such an incorrect or incomplete electronic data-file. One thing that the proxy server 14 may do after verifying the integrity and completeness of an electronic data-file it has received from the host server 20, is to transmit the electronic data-file or a derivative of the electronic data-file to one or more of the fuel-dispenser information-processing device(s) 17. It is possible for a malefactor to tamper with electronic data-files after they have been transmitted from the proxy server 14 to a fuel-dispenser information-processing device 17 and stored in computer memory thereof. According to one embodiment of the present invention the operating instructions of the proxy server 14 cause it to periodically and repeatedly retrieve from computer memory of one or more of the fuel-dispenser information-processing device(s) 17 electronic data-files stored therein and perform a check sum operation upon those electronic data-files. By periodically performing a check sum operation upon electronic data-files stored in computer memory of and utilized by the fuel-dispenser information-processing device(s) 17 the proxy server 14 can ensure that those electronic data-files are complete and correct. The proxy server 14 may perform check sum operations upon electronic data-files utilized by the fueling-station information-processing network 10 in any of a number of ways that are well known to and/or easily imaginable by one of ordinary skill in the art.

The fueling-station information-processing network 10 may have one or more fuel-dispenser information-processing device(s) 17 that include display screen(s) 13 for displaying information for viewing by customers. The fueling-station information-processing network 10 may comprise display screen(s) 13 of any of a number of different types including but not limited to CRTs (Cathode Ray Tubes) and LCDs (Liquid Crystal Displays). The fueling-station information-processing network 10 may further include one or more customer interface(s) 18 that a customer can utilize to communicate with the information-processing devices of the fueling-station information-processing network 10. Customer interface(s) 18 of the fueling-station information-processing network 10 may have any of a number of configurations well known to or easily imaginable by one of ordinary skill in the art. Customer interface(s) 18 of the fueling-station information-processing network 10 may comprise input devices including but not limited to operating button(s) 22, key pad(s), or touch screen systems. Additionally, the configuration of the fueling-station information-processing network 10 may be such that it will display a web-page of the customer's choice or a derivative of a web-page of the customer's choice upon one or more of the display screen(s) 13 after the customer commands it to do so by operating one of the customer interface(s) 18. Upon a customer operating a customer interface 18, of such a fueling-station information-processing network 10, to command it to display a web page of the customer's choice, the fuel-dispenser information-processing device 17 that comprises the customer interface 18 communicates the command to the proxy server 14. The proxy server 14 thereafter requests, from the host server 20, a web-page file for the web page of the customer's choice. If the web-page file is located in computer memory of the host server 20 or within computer memory of an information-processing device to which the host server 20 is communicatively linked, the host server 20 transmits the web-page file to the proxy server 14. The proxy server 14 thereafter transmits the web-page file or a derivative thereof to the fuel-dispenser information-processing device 17 the customer interface 18 of which the customer has operated to command the fueling-station information-processing network 10 to display the web page of their choice. This fuel-dispenser information-processing device 17 thereafter displays the web page of the customer's choice or a derivative of the web page of the customer's choice upon a display screen 13 of the fuel-dispenser information-processing device 17. A customer can utilize a fueling-station information-processing network 10, so configured, to view upon display screen(s) 13 thereof any web page the web-page file of which is accessible by the fueling-station information-processing network 10 unless provisions are made to limit the extent of such browsing. For example, if such a fueling-station information-processing network 10 were communicatively linked to the world wide web and no provisions were made to limit the extent to which the customer could browse web pages of the world wide web, the customers could view upon the display screen(s) 13 virtually any web page on the world wide web. Connection of the fueling-station information-processing network 10 to the world wide web is desirable in order to allow easy access to very valuable resources on the world wide web, yet unchecked browsing of the world wide web by customers generally would have a negative effect upon revenue generation for the fuel vendor. According to one embodiment of the present invention a predetermined-list of preferred web-pages is stored in computer memory of the fuel-dispenser information-processing device(s) 17, the proxy server 14, and/or the host server 20. In this embodiment of the invention the fueling-station information-processing network 10 is operable to display upon its display screen(s) 13 only web pages contained within this predetermined-list of preferred web-pages or derivatives thereof. Examples of web pages that a fuel vendor may desire to limit the customer's browsing to may include web pages that have information related to weather, news, financial information, the goods and services available from the fuel vendor, and local commerce.

Limiting of the customer's browsing to the web pages contained in the predetermined-list of preferred web-pages can be accomplished in one of two ways. The customer interface(s) 18 may be configured in such a manner that the customer has the option to request display of only the web pages within the predetermined-list of preferred web-pages. For example, the customer interface may comprise a touch-screen which displays upon it web-page identifier(s) 21 that the customer can select from. Such a system may be configured to limit the customer's browsing to those web pages in the predetermined-list of preferred web-pages by displaying upon the touch screen only web page identifier(s) 21 of web-pages contained in the predetermined-list of preferred web-pages. Alternatively a customer interface 18 may be configured in such a manner that a customer may input requests to view virtually any web page. In order to limit the customer's browsing of web pages in such a situation, a fueling-station information-processing network would check to see if a web page requested by the customer is included within the predetermined-list of preferred web-pages. If the web page requested by the customer is included in the predetermined-list of preferred web-pages the fueling-station information-processing network 10 would proceed to display the web page or a derivative thereof upon one or more of its display screen(s) 13. If the web page requested by the customer is not included in the predetermined-list of preferred web pages the fueling-station information-processing network 10 would not display the web page or any derivative thereof upon its display screen(s) 13. Of course it will be understood that preferably, the configuration of the fueling-station information-processing network 10 is such that the fuel vendor can modify the predetermined-list of preferred web-pages at their discretion.

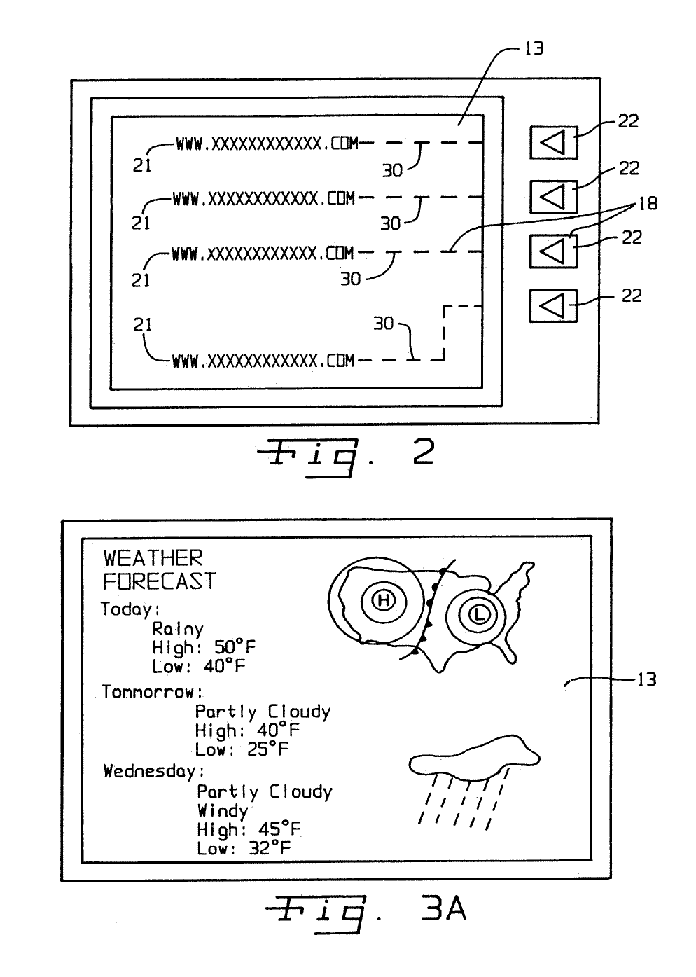

As was mentioned above, the fueling-station information-processing network 10 may comprise one or more customer interface(s) 18 of any of a number of different configurations for allowing a customer to communicate a request to view a web page or a derivative thereof upon a display screen 13. According to one embodiment of the present invention the fueling-station information-processing network comprises a particularly novel customer interface 18, an example of which is shown in FIG. 2. The customer interface 18 shown in FIG. 2 comprises a display screen 13 with a plurality of operating buttons 22 disposed adjacent the display screen 13. This customer interface 18 further comprises one or more web-page identifiers 21 displayed upon the display screen 13 in such a manner that each of the web-page identifiers 21 can be understood to correspond to one of the operating buttons 22. There are a number of ways in which a web-page identifier 21 can be displayed upon the display screen 13 such that it can be understood to correspond to one of the operating buttons 22. One such way is by displaying the web-page identifier 21 directly adjacent an operating button 22 to which it corresponds. Another way is to display the web-page identifier 21 anywhere upon the display screen 13 and to display a leader line 30 that extends between the web-page identifier 21 and the operating button 22 to which it corresponds. Additionally, it will be understood that a web-page identifier 21 may be a human-readable URL as is depicted in FIG. 2 or virtually any textual or graphic display that communicates either the name or the general subject matter of the web page to which the web-page identifier 21 corresponds. The customer interface 18 further includes operating instructions for the fueling-station information-processing network 10 that cause it to at least attempt to retrieve a source electronic-data-file which contains a web page corresponding to one of the web-page identifiers 21 when a customer presses the operating button 22 that corresponds to that web-page identifier 21. Thus, when the customer presses one of the operating buttons 22 corresponding to a web-page identifier 21 of such a customer interface 18 the web page corresponding to the web-page identifier or a derivative of the web page corresponding to the web-page identifier 21 is subsequently displayed upon the display screen 13. It will be understood that such a customer interface 18 as described directly above and shown in FIG. 2 is considered novel for any information-processing network regardless of whether or not that information-processing network is associated with a fueling station 29.

As mentioned above, the predetermined-list of preferred web-pages may comprise web pages containing information related to local commerce. Such web pages related to local commerce may comprise information related to local business such as what goods and services they offer, pricing information for those goods and services, the locations of the businesses and driving directions from the fueling station to the business, and promotional information such as coupons. Allowing customers to access web pages that contain such information can be advantageous to the fuel vendor in a number of ways. By providing a customer easy access to such information about local commerce, the fuel vendor has a competitive advantage over fuel vendors who do not do so and can, thus, realize increased revenues through increased fuel sales. Additionally, the fuel vendor has the opportunity to generate advertising revenues from those local businesses that wish to have information about them accessible to the customer through the fuel vendor's fueling-station information-processing network 10.

The fueling-station information-processing network 10 may have more than one type of display screen 13 and the different types of display screens 13 may have different display capabilities. For instance, the fueling-station information-processing network 10 may comprise display screens 13 that are 10.4 display screens, ¼VGA display screens, and 4-line display screens. A 10.4 display screen would generally have display capabilities sufficient to display complex groupings of text, images, and/or pictures such as those contained in most HTML (Hyper Text Markup Language) files that are accessible via the world wide web. By contrast, ¼VGA and 4-line displays would not typically have display capabilities sufficient to display all of the content (including text, graphics, and/or pictures) of most HTML files accessible via the world wide web. In fact, 4-line display screens are only capable of displaying text. A considerable portion of the most useful information available via the world's information networks (such as the world wide web) is contained within electronic data-files that have that information formatted for display upon display screens 13 with extensive display capabilities such as 10.4 display screens. Although these electronic-data files (such as HTML documents accessible via the world wide web) contain very useful information, their complexity is too great for them to be displayed upon display screens such as ¼VGA and 4-line display screens, which have less extensive display capabilities.

According to one embodiment of the present invention the fueling-station information-processing network 10 is capable of displaying upon display screen(s) 13 thereof that have limited display capabilities, information derived from electronic data-files, such as HTML files accessible via the world wide web, that are too complex to be displayed in their entirety upon the display screen(s) 13 with limited display capabilities. According to this embodiment, the proxy server 14 receives from the host server 20 a source electronic-data-file that comprises information such as text, graphics, and/or pictures for display upon one or more of the display screen(s) 13 of the fueling-station information-processing network 10. The proxy server 14 thereafter determines whether or not the all of the contents and formatting of the source electronic-data-file can be displayed upon any of the different types of display screen(s) 13 upon which information from the source electronic-data-file is to be displayed. If it is determined, by the proxy server, that some of the display screen(s) 13 are capable of displaying the content of the source electronic-data-file as it is configured upon receipt, the proxy server 14 transmits the source electronic-data-file to those fuel-dispenser information-processing device(s) 17 which comprise those display screen(s) 13, which are capable of displaying the source electronic-data-file as is. If it is determined by the proxy server 14 that some of the display screen(s) 13 have insufficient display capabilities to display the content of the source electronic-data-file, as it is configured upon receipt by the proxy server 14, the proxy server 14 creates one or more reduced-content electronic-data-files. Each reduced-content electronic-data-file created by the proxy server 14 comprises text, graphics, and/or pictures selected from the source electronic-data-file. Each reduced-content electronic-data-file is configured in such a manner that its contents can be properly displayed upon one of the types of display screen(s) 13 that are incapable of displaying the full contents of the source electronic-data-file. For exemplary purposes consider a situation in which a fueling-station information-processing network comprises 10.4 display screens, ¼VGA display screens, and 4-line display screens and content from a complex HTML file that contains text, graphics, and pictures is to be displayed upon all three different kinds of display screen(s) 13. After receiving the source electronic-data-file, which is the complex HTML file, the proxy server 14 determines that the 10.4 display screens of the fueling-station information-processing network 10 are capable of displaying all of the contents of the source electronic-data-file as it is configured upon receipt from the host server 20. The proxy server 14 thereafter transmits the complex HTML file to those fuel-dispenser information-processing device(s) 17 which comprise 10.4 display screen(s) and the contents of the HTML file are displayed upon those display screen(s) 13. After receiving the source electronic-data-file, which is the complex HTML file, the proxy server creates a first reduced-content electronic-data-file for display upon the ¼VGA display screen(s) and a second reduced-content electronic-data-file for display upon the 4-line display screen(s). The first reduced-content electronic-data-file would contain a subset of the text, graphics, and/or pictures of the complex HTML file and is formatted in such a manner that its contents are displayable upon the ¼VGA display screen(s). The second reduced-content electronic-data-file contains only text selected from the complex HTML file and formatted in such a manner that it can be displayed upon the 4-line display screen(s). After it is created by the proxy server 14, the first reduced-content electronic-data-file is transmitted by the proxy server 14 to those fuel-dispenser information-processing device(s) 17 that comprise ¼VGA display screen(s) upon which information from the complex HTML file is to be displayed. Likewise, after it is created by the proxy server 14, the second reduced-content electronic-data-file is transmitted by the proxy server 14 to those fuel-dispenser information-processing device(s) 17 that comprise 4-line display screen(s) upon which information from the complex HTML file is to be displayed. Such a configuration and operation of the fueling-station information-processing network 10 has a number of advantages. Display screens 13 with limited display capabilities can be utilized to display information that is most readily available in electronic data-files that are too complex to be displayed in their entirety upon the display screens 13 with limited display capabilities. Additionally, fueling-station information-processing networks 10 can easily, simultaneously, display upon multiple display screens 13, with differing display capabilities, information from a common source electronic-data-file.

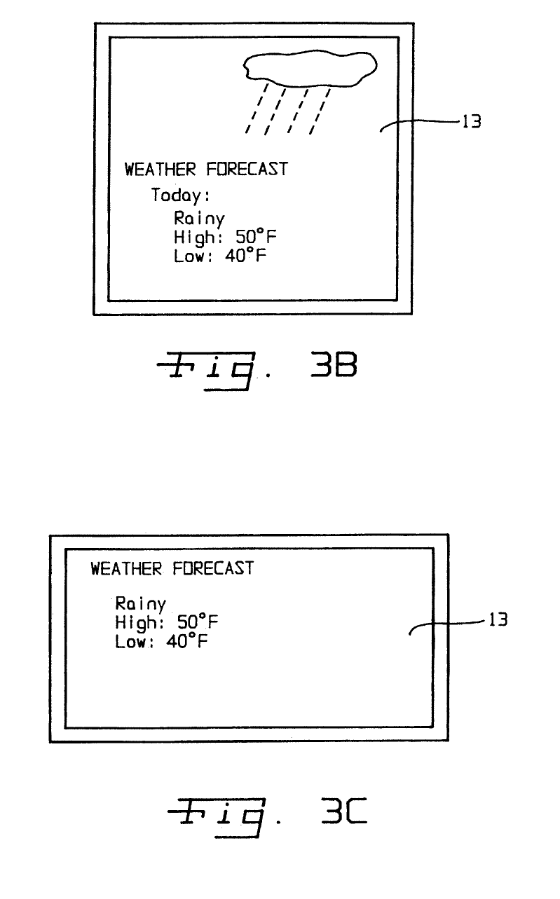

FIGS. 3a, 3b, and 3c are illustrative of information from a common source electronic-data-file being displayed upon display screens 13 with differing display capabilities. The display screen 13 in FIG. 3a has greater display capabilities than the display screen 13 in FIG. 3b, which has greater display capabilities than the display screen 13 in FIG. 3c. Each of the display screens 13 in FIGS. 3a, 3b, and 3c are shown displaying information from a common source electronic-data-file that is an HTML file that comprises information related to the weather. These figures illustrate the types of changes that the proxy server 14 may make from a source electronic-data-file when creating reduced-content electronic-data-files, from the source electronic-data-file, for display upon display screens 13 with limited display capabilities. The information displayed upon the display screen 13 in FIG. 3a is typical of the information that would be included in a source electronic-data-file as received by the proxy server 14. The information displayed upon the display screen 13 shown in FIG. 3b is typical of information that would be included in a reduced-content electronic-data-file tailored to a display screen 13 with somewhat limited display capabilities. Finally, the information displayed upon the display screen 13 shown in FIG. 3c is typical of information that would be included in a reduced-content electronic-data-file tailored to a display screen 13 with very limited display capabilities.

There are two general means contemplated by the present invention by which the proxy server 14 may create from a source electronic-data-file a reduced-content electronic-data-file. The proxy server 14 may operate according to standard file-conversion rules to create a reduced-content electronic-data-file or the proxy server may operate according to custom file-conversion rules specific to the source electronic-data-file to create a reduced-content electronic-data-file. Standard file-conversion rules are operating instructions stored in computer memory of the proxy server 14 which the proxy server 14 can operate according to in order to create a reduced-content electronic data-file from a source electronic-data-file that contains text, graphics, and/or pictures. Standard file-conversion rules for creating a reduced-content electronic-data-file must be generic to a large number of possible source electronic-data-files. Custom file-conversion rules are operating instructions that are received by the proxy server 14 with a source electronic-data-file and which the proxy server 14 can operate according to and create one or more reduced-content electronic-data-files from the source electronic-data-file. Each set of custom file-conversion-rules for creating a reduced-content electronic-data-file may be specific to the source electronic-data-file with which it is associated.

Standard file-conversion rules according to which the proxy server 14 operates in order to create reduced-content electronic-data-files may have any number of forms. For purposes of understanding, a simplistic example of some standard file-conversion rules according to which a proxy server 14 may operate is included hereinafter. A proxy server 14 may have stored in computer memory thereof standard file-conversion rules for creating from a source electronic-data-file, such as an HTML file, a reduced-content electronic-data-file for display upon a ¼VGA display screen. These standard file-conversion rules could, for instance, cause the proxy server 14 to reduce the number of colors in the reduced-content electronic-data-files for the ¼VGA screen as compared to the source electronic-data-file. The standard file-conversion rules could further cause the proxy server 14 to always select only the first of any graphics that are included in the source electronic-data-file for inclusion in the reduced-content electronic-data-file for the ¼VGA display screen. The standard file-conversion rules could, further, cause the proxy server to select text including a header, a first paragraph, and a footer of the source electronic-data-file for inclusion in the reduced-content electronic-data-file for the ¼VGA display screen. The standard file-conversion rules according to which the proxy server 14 would operate to create reduced-content electronic-data-files for display upon 4-line display screens would obviously be different than the above-described hypothetical standard file-conversion rules for creating reduced-content electronic-data-files for display upon ¼VGA display screens. Standard file conversion-rules for creating reduced-content electronic-data-files for display upon 4-line display screens would cause the proxy server 14 to select from the source electronic-data file only four lines of text to be displayed upon the 4-line display screens. These standard file-conversion rules could, for instance, cause the proxy server 14 to select a header, the first two lines of body text, and a footer of the source electronic-data-file for the reduced-content electronic-data-file for display upon 4-line displays. It will be understood that the specific examples of standard file-conversion rules described herein above are included to facilitate understanding of the general nature of standard file-conversion rules for creating reduced-content electronic-data-files for display upon display screens 13 with limited display capabilities and that many other embodiments of standard file-conversion rules could be utilized by a proxy sever 14 according to the present invention. The use of standard file-conversion rules by the proxy server 14 to create reduced-content electronic-data-files, thus, allows for the display of valuable information derived from complex source electronic-data-files upon display screens 13 with display capabilities insufficient to display the full content of the source electronic-data-files.

While the use of standard file-conversion rules by the proxy server 14 to create reduced-content electronic-data-files for display upon display screens 13 with limited display capabilities has obvious advantages, there are situations in which such a method of operation would result in less than optimum configuration of the reduced-content electronic-data-files. For instance, the standard file-conversion rules specified might be such that the first paragraph and not the second paragraph of the source electronic-data-file be used in creation of a reduced-content electronic-data-file for a ¼VGA display screen. If the second paragraph of text of a given source electronic-data-file is more informative than the first, the reduced-content electronic-data-file resulting from the proxy server 14 operating in accordance with such standard file-conversion rules would be less than ideal because it would include the first paragraph and not the second. For this reason there are situations in which it is desirable that the proxy server 14 create reduced-content electronic-data-tiles from a source electronic-data-file by using custom file-conversion rules that are transmitted to the proxy server 14 with the source electronic-data-file. Custom file-conversion rules accompanying a source electronic-data-file would be configured by the creator of the source electronic-data-file and would be a set of rules that would define which elements of the contents should be included and how those elements should be formatted in the creation of reduced-content electronic-data-files for certain types of display screens. For instance a source electronic-data-file may contain data such as text, graphics, and/or pictures and custom file-conversion rules for creating reduced-content electronic-data-files for ¼VGA display screens and 4-line display screens. The custom file-conversion rules for creating reduced-content electronic-data-files for ¼VGA may specify to use the header text, the footer text, the second paragraph of the body text, and the second picture of the source electronic-data-file. The custom file-conversion rules for creating reduced-content electronic-data-files for 4-line displays may specify to use the header text, the first two lines of the body text and the footer text from the source electronic-data-file. Thus, reduced-content electronic-data-files created in accordance with custom file-conversion rules that are specific to the source electronic-data-files are optimized for display upon the type of display screens 13 that they are to be displayed upon.

According to one embodiment of the present invention the fueling-station information-processing network 10 is capable of creating reduced-content electronic-data-files for display upon display screen(s) 13 with limited display capabilities by using either standard file-conversion rules or custom file-conversion rules. In this embodiment, when the proxy server 14 receives a source electronic-data-file with text, graphics, and/or pictures for display upon one or more display screen(s) 13 that have limited display capabilities, the proxy server 14 ascertains whether or not the source electronic-data-file is accompanied by custom file-conversion rules for the types of display screen(s) 13 upon which the information from the source electronic-data-file is to be displayed. If the source electronic-data-file does comprise the appropriate custom file-conversion rules, the proxy server 14 operates according to those custom file-conversion rules to create the reduced-content electronic-data-files. If there are any types of display-screen(s) 13 upon which information from the source electronic-data-file is to be displayed and for which there are no custom file-conversion rules included with the source electronic-data-file, the proxy server 14 utilizes standard file-conversion rules to create reduced-content electronic-data-files for those types of display screen(s) 13. Thus, such a configuration and operation of a fueling-station information-processing network enables optimized configuration of information displayed upon display screen(s) 13 with limited display capabilities when custom file-conversion rules are available while ensuring that information from a source electronic-data-file can be displayed upon any types display screen(s) 13 with limited display capabilities.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-9. (canceled)

10. A fueling-station information processing system, comprising:
at least one fuel dispenser station, each fuel dispenser station comprising at least one fuel dispenser useable to control dispensation of fuel;
at least one fuel dispenser information processing device mounted to each said fuel dispenser station;
a proxy server communicatively linked to each said fuel dispenser information processing device, and
a host server communicatively linked to said proxy server,
wherein the proxy server comprises components for receiving an electronic data file from said host server and for performing a check sum operation upon said electronic data file in order to verify integrity and completeness of said electronic data file, wherein if said electronic data file is complete and correct, the proxy server transmits electronic data file information to each said fuel dispenser information processing device.

11. The fueling-station information processing system of claim 10, further comprising:
local computer-memory in each fuel dispenser information processing device configured to store said electronic data file after receiving it from said proxy server; and
retrieval components within the proxy server for repeatedly and periodically retrieving from said local computer-memory of said fuel dispenser information processing device said electronic data file stored therein and performing a check sum operation in order to verify integrity and completeness of said electronic data file.

12. The fueling-station information processing system of claim 11, wherein:
each said fuel dispenser information processing device comprises a display screen; and
said proxy server is configured and communicatively linked to each said fuel dispenser information processing device and said electronic data file acted upon by said proxy server comprises at least one of text, graphics, and pictures for display upon said display screen.

13. The fueling-station information processing system of claim 12, further comprising:
at least two fuel dispenser information processing devices which comprise display screens;
at least two different types of said display screens, each said type having distinct capabilities;
determining components within the proxy server for determining whether said electronic-data file is fully formatted and can be properly displayed upon said types of display screens without modification;
transmission components within said proxy server for transmitting said electronic data file to any of said fuel dispenser information processing devices that comprise types of display screens that have display capabilities sufficient to display said source electronic data file without modification; and
construction components within said proxy server for constructing from said electronic data file reduced content electronic data files formatted in a manner tailored for display upon display screens with insufficient display capabilities to display said electronic data file without modification, wherein the transmission components further transmit each different type of reduced-content electronic-data file to said fuel dispenser information processing devices having display screens with display capabilities to which said reduced content electronic data files are tailored.

14. The fueling-station information processing system of claim 10, wherein the electronic data file comprises fuel dispenser operating instructions for controlling operations of each said fuel dispenser information processing device.

15. A fueling-station information processing system, comprising:
at least one fuel dispenser station, each fuel dispenser station comprising at least one fuel dispenser useable to control dispensation of fuel;
at least one fuel dispenser information processing device mounted to each said fuel dispenser station, each said fuel dispenser information processing device comprising a display screen and a customer interface, wherein each said customer interface is operable by a customer to communicate a request to said fueling-station information processing system that web page information of the customer's choice be displayed upon said display screen;
a proxy server communicatively linked to each said fuel dispenser information processing device, and
a host server communicatively linked to said proxy server,
wherein a predetermined-list of preferred web-pages is stored within computer memory contained in one of said proxy server, each said fuel dispenser information processing device, and said host server, and display of web page information is limited to information on the predetermined list.

16. The fueling-station information processing system of claim 15, wherein
each said customer interface comprises:
at least one operating button disposed adjacent said display screen and communicatively linked to said fuel dispenser information processing device;
at least one web-page identifier displayed upon each said display screen to be understood by the customer to correspond to one of said operating buttons of said customer interface; and
wherein said fueling-station information processing system comprises display components for displaying upon each said display screen web page information of the customer's choice after the customer communicates the choice to said fueling-station information processing system by pressing one of said operating buttons, corresponding to a web-page identifier of the customer's choice.

17. The fueling-station information processing system of claim 15, wherein:
said list of preferred web-pages comprises web pages that include information related to local commerce.
